(19) United States
(12) Patent Application Publication
(10) Pub. No.: US 2006/0022526 A1
(43) Pub. Date: Feb. 2, 2006

(54) Asymmetric radio-frequency switch

(76) Inventor: David Cartalade, Paris (FR)

Correspondence Address: KENYON & KENYON, Suite 600, 333 W. San Carlos, Street, San Jose, CA, 95110-2711, US

(21) Appl. No.: 10/900,700

(22) Filed: Jul. 27, 2004

(51) Int. Cl. B23K 11/24

(52) U.S. Cl. 307/112

(57) ABSTRACT

A radio frequency switch with reduced noise on the receiving side and optimizes linearity on the transmitting side by using an asymmetric metal-oxide semiconductor (MOS) transistor structure is disclosed. In one embodiment, low voltage threshold MOS structures are used on the receiving side and high voltage threshold MOS structures are used on the transmitting side. Dynamic threshold MOS transistors may be used on the receiving side. The MOS transistors on the transmitting side may be arranged in serially connected pairs. Adjustment signals may be used to create an apparent low threshold or an apparent high threshold.

### BACKGROUND INFORMATION

The present invention relates to the architecture of a radio frequency single pole dual throw switch. Specifically, the present invention relates to a radio frequency switch with an asymmetric architecture.

Radio frequency (RF) switching circuits 100 with a single pole dual throw (SPDT) configuration have a symmetric architecture between antenna and reception and between antenna and emission, as shown, for example, in FIG. 1. A receiving side 110 of the switching circuit 100 connects a receiving circuit (RX) via a first port 120 to an antenna (ANT) via a second port 130. A transmitting side 140 of the switching circuit 100 connects a transmitting circuit (TX) via a third port 150 to the antenna via the second port 130. On the receiving side 110, a first N-type metal-oxide semiconductor (NMOS) transistor 112 connects the first port 120 to ground 160. A first gate resistor 114 connects a first control signal voltage 170 to the gate of the first NMOS transistor 112. A second NMOS transistor 116 connects the first port 120 to the second port 130. A second gate resistor 118 connects a second control signal voltage 180 to the gate of the second NMOS transistor 116. The second control signal voltage 180 has an opposite value from the first voltage 170, so that the first NMOS transistor 112 is active when the second NMOS transmitter 116 is inactive, and vice versa. On the transmitting side 140, a third NMOS transistor 142 connects the third port 150 to ground 160. A third gate resistor 144 connects the second control signal voltage 180 to the gate of the third NMOS transistor 142. A fourth NMOS transistor 146 connects the third port 150 to the second port 130. A fourth gate resistor 148 connects the first control signal voltage 170 to the gate of the fourth NMOS transistor 146. The gate resistors are added to create a high impedance state to the gates to reduce capacitance effects and insertion losses.

### SUMMARY OF THE INVENTION

A radio frequency switch with reduced noise on the receiving side and optimized linearity on the transmitting side by using an asymmetric metal-oxide semiconductor (MOS) transistor structure is disclosed. In one embodiment, low voltage threshold MOS structures may be used on the receiving side and high voltage threshold MOS structures may be used on the transmitting side. Dynamic threshold MOS transistors may be used on the receiving side. The MOS transistors on the transmitting side may be arranged in serially connected pairs. Adjustment signals may be used to create an apparent low threshold or an apparent high threshold.

### BRIEF DESCRIPTION OF THE DRAWINGS

FIG. 1 illustrates a symmetric radio frequency single pole dual throw switching circuit as known in the art.

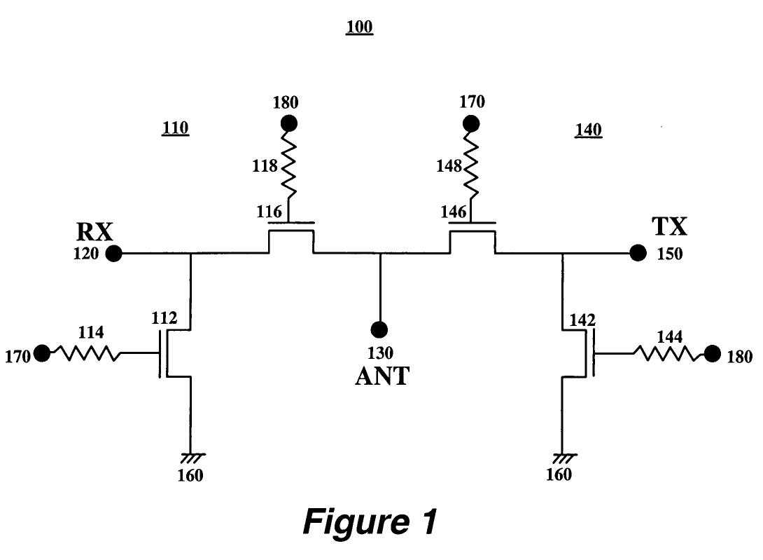

FIG. 2 illustrates one embodiment of an asymmetric radio frequency single pole dual throw switching circuit according to the present invention.

FIGS. 3a-b illustrate in flowcharts one embodiment of a method of using the asymmetric switching circuit of FIG. 2.

FIG. 4 illustrates an alternate embodiment of an asymmetric radio frequency single pole dual throw switching circuit according to the present invention.

FIGS. 5a-b illustrate in flowcharts one embodiment of a method of using the asymmetric switching circuit of FIG. 4.

FIG. 6 illustrates a further embodiment of an asymmetric radio frequency single pole dual throw switching circuit according to the present invention.

FIG. 7 illustrates another embodiment of an asymmetric radio frequency single pole dual throw switching circuit according to the present invention.

### DETAILED DESCRIPTION

A radio frequency (RF) switch with reduced noise on the receiving side and optimized linearity on the transmitting side by using an asymmetric metal-oxide semiconductor (MOS) transistor structure is disclosed. In one embodiment, low voltage threshold MOS structures may be used on the receiving side and high voltage threshold MOS structures may be used on the transmitting side. Dynamic threshold MOS transistors may be used on the receiving side to achieve low threshold voltage when in an active state. The MOS transistors on the transmitting side may be arranged in serially connected pairs to have a higher apparent threshold voltage. Adjustment signals may be used to create an apparent low threshold or an apparent high threshold.

Silicon on insulator (SOI) circuits may be used to create asymmetric RF switches. Parasitic capacitors are reduced in SOI circuits due to the oxide insulating layer and the resistive substrate, leading to higher RF performances for RF structures such as switches. The insertion losses and the isolation are improvements over a standard complementary metal-oxide semiconductor (CMOS). Further, SOI enables the use of dynamic threshold MOS (DTMOS) transistors, with a connection to the transistor body available, enabling a lower threshold voltage in the active state and thus a reduction of the insertion losses.

The electrical performances of RF switches are usually related, in particular, to two parameters of the technology: threshold voltage (Vt) and the power supply voltage used for the control signals (V_{CC}). Increasing the difference between V_{CC} and Vt reduces the insertion losses. To optimize linearity, the differential between the V_{CC} and Vt should be reduced.

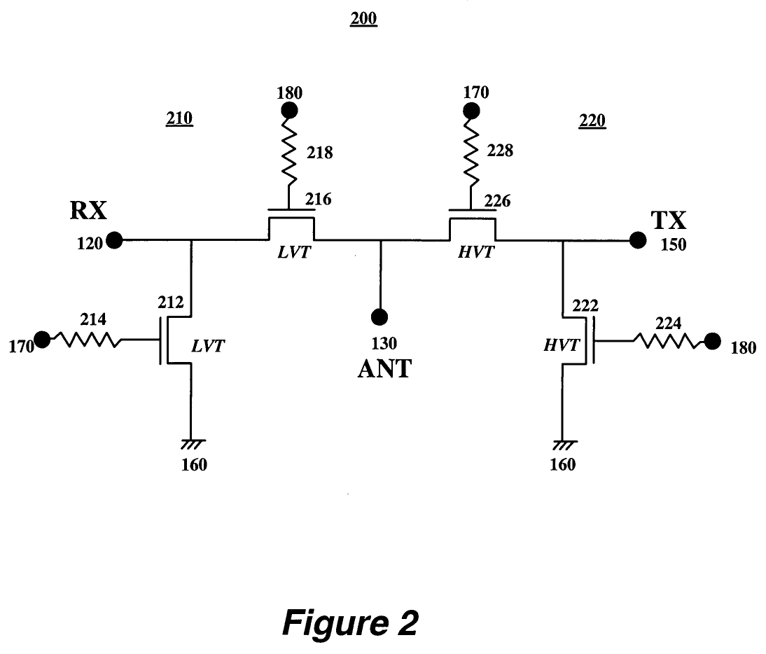

FIG. 2 illustrates one embodiment of an asymmetric switching circuit 200. Due to the different constraints of the receiving side 210 and the transmitting side 220, the use of a low Vt (LVT) N-type metal-oxide semiconductor (NMOS) for the receiving side 210 and a high Vt (HVT) NMOS for the transmitting side 220 enable a better performance. On the receiving side 210, a first LVT NMOS transistor 212 connects the first port 120 to ground 160. A first gate resistor 214 connects a first control signal voltage 170 to the gate of the first LVT NMOS transistor 212. A second LVT NMOS transistor 216 connects the first port 120 to the second port 130. A second gate resistor 218 connects a second control signal voltage 180 to the gate of the second LVT NMOS transistor 216. On the transmitting side 220, a first HVT NMOS transistor 222 connects the third port 150 to ground 160. A third gate resistor 224 connects the second control signal voltage 180 to the gate of the first HVT NMOS transistor 222. A second HVT NMOS transistor 226 connects the third port 150 to the second port 130. A fourth gate resistor 228 connects the first control signal voltage 170 to the gate of the second HVT NMOS transistor 226.

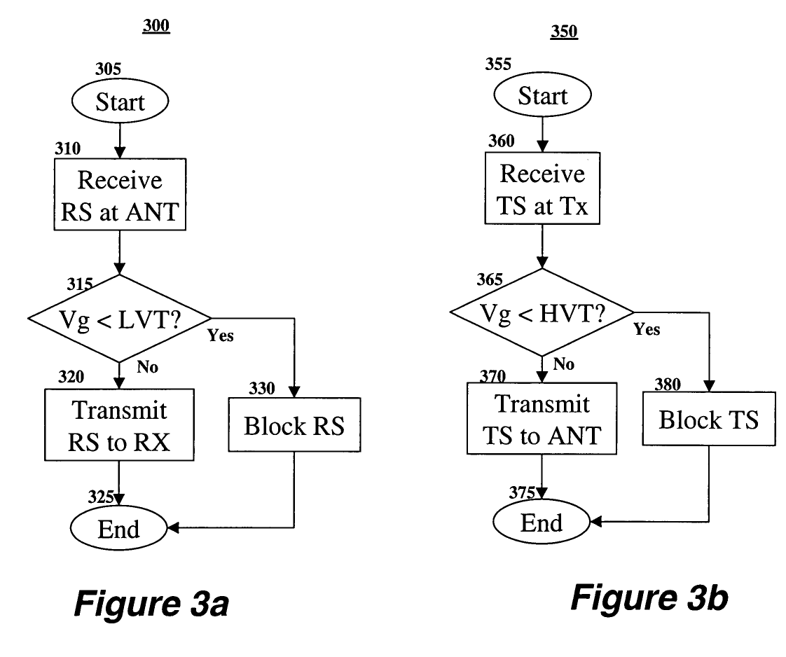

FIGS. 3a-b illustrate in flowcharts one embodiment of a method of using the asymmetric switching circuit of FIG. 2. FIG. 3a illustrates a method 300 of using the receiving side 210. The process starts (Block 305) by receiving a reception signal (RS) at the antenna (ANT) and transmitting the RS to the source of the second LVT NMOS transistor 216 (Block 310). If the gate voltage (Vg) of the second LVT NMOS transistor 216 is greater than or equal to the LVT (Block 315), then the RS is transmitted from the source to the drain, reaching the receiving circuit (RX) (Block 320), ending the process (Block 325). The Vg is equal to VC 170 or VCB 180 minus the voltage that is dissipated by the gate resistor 218. In many cases, Vg is equivalent to VC 170 or VCB 180, as the voltage dissipated by the resistor is negligible. If Vg of the second LVT NMOS transistor 216 is less than the LVT (Block 315), then the second LVT NMOS transistor 216 blocks the RS (Block 330), ending the process (Block 325).

FIG. 3b illustrates a method 350 of using the transmitting side 220. The process starts (Block 355) by receiving a transmission signal (TS) from the transmitting circuit (TX) and transmitting the TS to the source of the second HVT NMOS transistor 226 (Block 360). If Vg of the second HVT NMOS transistor 226 is greater than or equal to the HVT (Block 365), then the TS is transmitted from the source to the drain, reaching the ANT (Block 370), ending the process (Block 375). If Vg of the second HVT NMOS transistor 226 is less than the HVT (Block 365), then the second HVT NMOS transistor 226 blocks the TS (Block 380), ending the process (Block 375).

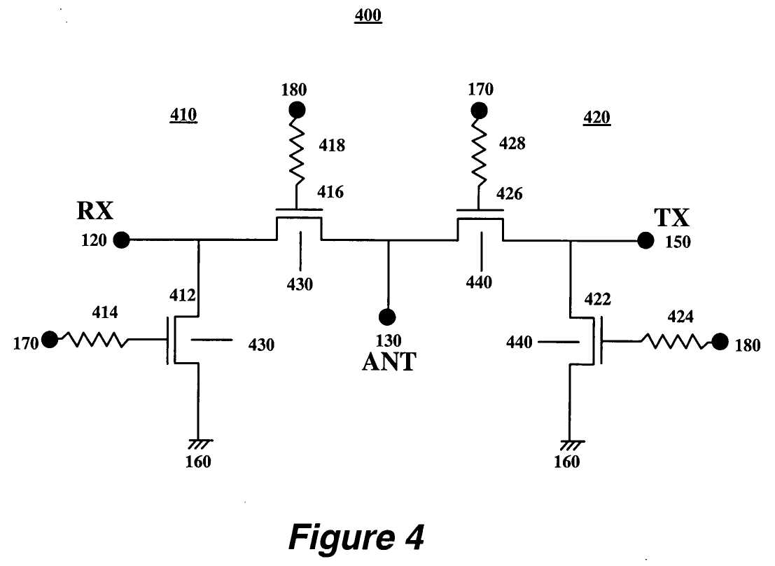

FIG. 4 illustrates a different embodiment of an asymmetric switching circuit 400. If NMOS transistors with only one threshold voltage are available, the needed asymmetry is generated using the body connections of NMOS transistors on the receiving side 410 and on the transmitting side 420. The use of SOI circuits enables a voltage to be applied to the body of a transistor. A receiver voltage adjustment signal 430 is applied to the body of the NMOS transistors on the receiving side 410 to create a receiver threshold voltage. Further, a transmitter voltage adjustment signal 440 is applied to the body of the NMOS transistors on the transmitting side 420 to create a transmitter threshold voltage different from the receiver threshold voltage. The compromise between loss insertion and linearity is then a function of the difference between the receiver voltage adjustment signal 430 and the transmitter voltage adjustment signal 440.

On the receiving side 410, a first NMOS transistor 412 connects the first port 120 to ground 160. A first gate resistor 414 connects a first control signal voltage 170 to the gate of the first NMOS transistor 412. A second NMOS transistor 416 connects the first port 120 to the second port 130. A second gate resistor 418 connects a second control signal voltage 180 to the gate of the second NMOS transistor 416. The receiver voltage adjustment signal 430 is applied to the body of both the first NMOS transistor 412 and the second NMOS transistor 416. On the transmitting side 420, a third NMOS transistor 422 connects the third port 150 to ground 160. A third gate resistor 324 connects the second control signal voltage 180 to the gate of the third NMOS transistor 322. A fourth NMOS transistor 326 connects the third port 150 to the second port 130. A fourth gate resistor 328 connects the first control signal voltage 170 to the gate of the fourth NMOS transistor 326. The transmitter voltage adjustment signal 340 is applied to the body of both the third NMOS transistor 322 and the fourth NMOS transistor 326.

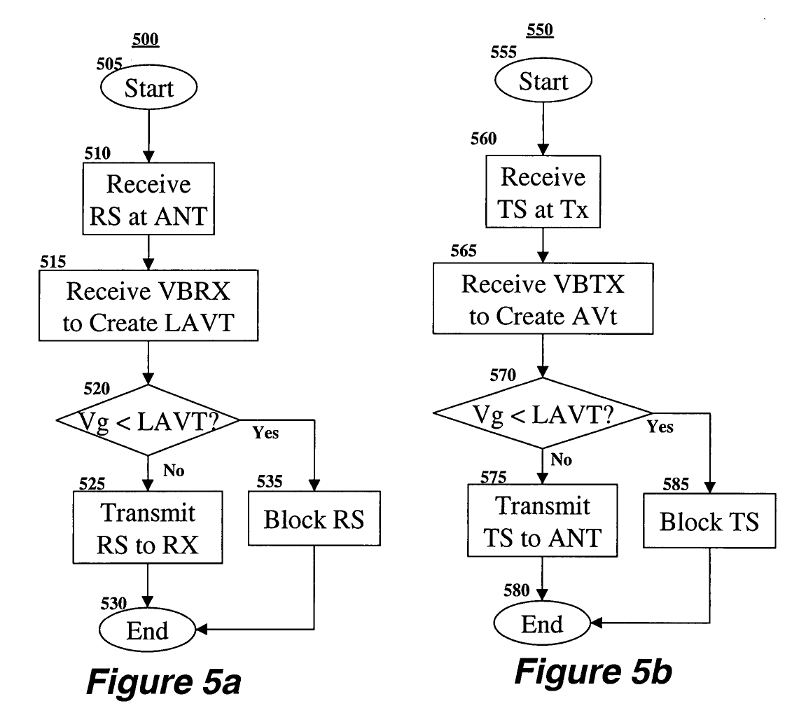

FIGS. 5a-b illustrate in flowcharts one embodiment of a method of using the asymmetric switching circuit of FIG. 4. FIG. 5a illustrates a method 500 of using the receiving side 410. The process starts (Block 505) by receiving an RS at the ANT and transmitting the RS to the source of the second NMOS transistor 416 (Block 510). A receiver voltage adjustment signal (VBRX) 430 is received at the body of the second NMOS transistor 416 to create a low apparent voltage threshold (LAVT) (Block 515). If the Vg of the second NMOS transistor 416 is greater than or equal to the LAVT (Block 520), then the RS is transmitted from the source to the drain, reaching the RX (Block 525), ending the process (Block 530). If the Vg of the second NMOS transistor 416 is less than the LVT (Block 520), then the second NMOS transistor 416 blocks the RS (Block 535), ending the process (Block 530).

FIG. 5b illustrates a method 550 of using the transmitting side 420. The process starts (Block 555) by receiving a TS from the TX and transmitting the TS to the source of the fourth NMOS transistor 426 (Block 560). A transmitter voltage adjustment signal (VBTX) 440 is received at the body of the fourth NMOS transistor 426 to create a high apparent voltage threshold (HAVT) (Block 565). If the Vg of the fourth NMOS transistor 426 is greater than or equal to the HAVT (Block 570), then the TS is transmitted from the source to the drain, reaching the ANT (Block 575), ending the process (Block 580). If the Vg of the fourth NMOS transistor 426 is less than the HAVT (Block 570), then the TS is blocked by the fourth NMOS transistor 426 (Block 585), ending the process (Block 580).

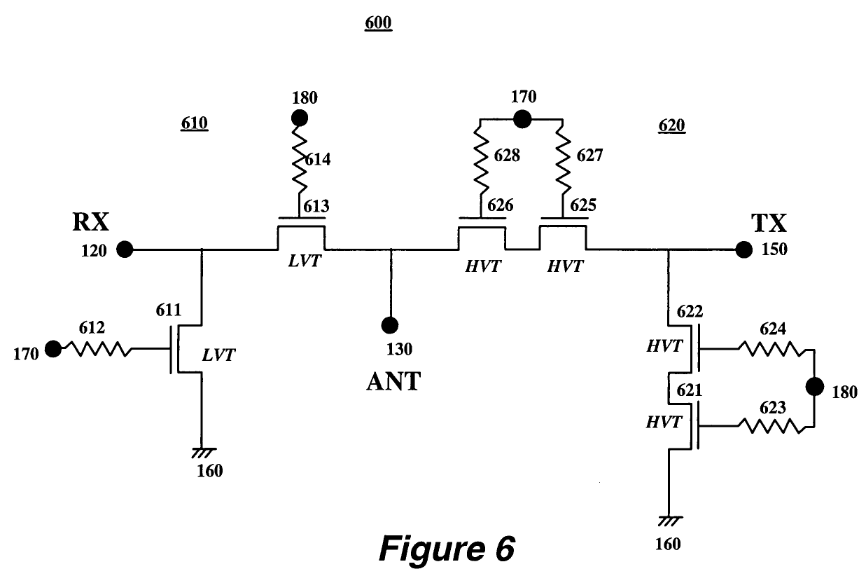

FIG. 6 illustrates another embodiment of an asymmetric switching circuit 600. This embodiment uses LVT NMOS transistors on the receiving side 610 and pairs of serially connected transistors on the transmitting side 620 to increase the apparent threshold voltage, leading to a higher compression point. On the receiving side 610, a first LVT NMOS transistor 611 connects the first port 120 to ground 160. A first gate resistor 612 connects a first control signal voltage 170 to the gate of the first LVT NMOS transistor 611. A second LVT NMOS transistor 613 connects the first port 120 to the second port 130. A second gate resistor 614 connects a second control signal voltage 180 to the gate of the second LVT NMOS transistor 613. On the transmitting side 620, a first HVT NMOS transistor 621 connected serially with a second HVT NMOS transistor 622 connect the third port 150 to ground 160. A third gate resistor 623 and a fourth gate resistor 624 connect the second control signal voltage 180 to the gate of the first HVT NMOS transistor 621 and the gate of the second HVT NMOS transistor 622. A third HVT NMOS transistor 625 connected serially with a fourth HVT NMOS transistor 626 connect the third port 150 to the second port 130. A fifth gate resistor 627 and a fourth gate resistor 628 connect the first control signal voltage 170 to the gate of the third HVT NMOS transistor 625 and the gate of the fourth HVT NMOS transistor 628.

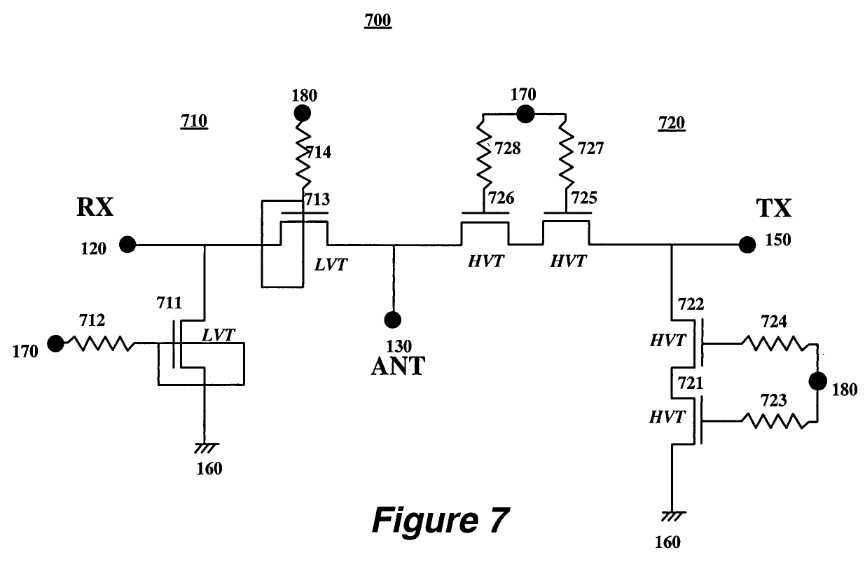

FIG. 7 illustrates a further embodiment of an asymmetric switching circuit 700. This embodiment is similar to the embodiment of FIG. 6, with SOI technology allowing DTMOS transistors to be used on the receiving side 710, while the transmitting side 720 remains the same. On the receiving side 710, a first LVT DTMOS transistor 711 connects the first port 120 to ground 160. A first gate resistor 712 connects a first control signal voltage 170 to the gate of the first LVT DTMOS transistor 711. A second LVT DTMOS transistor 713 connects the first port 120 to the second port 130. A second gate resistor 714 connects a second control signal voltage 180 to the gate of the second LVT DTMOS transistor 713. On the transmitting side 720, a first HVT NMOS transistor 721 connected serially with a second HVT NMOS transistor 722 connect the third port 150 to ground 160. A third gate resistor 723 and a fourth gate resistor 724 connect the second control signal voltage 180 to the gate of the first HVT NMOS transistor 721 and the gate of the second HVT NMOS transistor 722. A third HVT NMOS transistor 725 connected serially with a fourth HVT NMOS transistor 726 connect the third port 150 to the second port 130. A fifth gate resistor 727 and a fourth gate resistor 728 connect the first control signal voltage 170 to the gate of the third HVT NMOS transistor 725 and the gate of the fourth HVT NMOS transistor 728.

In the above description, for purposes of explanation, numerous specific details are set forth in order to provide a thorough understanding of the present invention. It will be apparent, however, to one skilled in the art that the present invention can be practiced without these specific details. For example, various methods may be used to create an asymmetric structure for the switching circuit. Additionally, alterations may be made to the switching circuit, such as removing or adding resistors and other components, and removing the transistor between the ports and the ground.

What is claimed is:

1. A radio frequency switch, comprising:
a first port to send incoming signals to a receiving circuit;
a second port to receive incoming signals from and send outgoing signals to an antenna;
a third port to receive outgoing signals from a transmitting circuit; and
a switching circuit having a receiving side connecting the first port to the second port and ground and a transmitting side connecting the third port to the second port and ground,
wherein the switching circuit has an asymmetric metal-oxide semiconductor transistor structure.

2. The radio frequency switch of claim 1, wherein metal-oxide semiconductor transistors of the receiving side receive a receiver adjustment signal to create a receiving apparent threshold voltage and metal-oxide semiconductor transistors of the transmitting side receive a transmitting adjustment signal to create a transmitter apparent threshold voltage.

3. The radio frequency switch of claim 1, wherein the receiving side is comprised of low threshold voltage transistors and the transmitting side is comprised of high threshold voltage transistors.

4. The radio frequency switch of claim 3, wherein the high threshold voltage transistors of the transmitting side are serially connected in pairs.

5. The radio frequency switch of claim 4, wherein the low threshold voltage transistors are silicon-on-insulator dynamic threshold metal-oxide semiconductor transistors.

6. The radio frequency switch of claim 1, wherein the transmitting side is comprised of serially connected pairs of transistors.

7. The radio frequency switch of claim 6, wherein the receiving side is comprised of silicon-on-insulator dynamic threshold metal-oxide semiconductor transistors.

8. A transceiver, comprising:
a receiving circuit to receive incoming signals;
an antenna to receive incoming signals from and send outgoing signals;
a transmitting circuit to send outgoing signals; and
a switching circuit having a receiving side connecting the receiving circuit to the antenna and a transmitting side connecting the antenna to the transmitting circuit,
wherein the switching circuit has an asymmetric metal-oxide semiconductor transistor structure.

9. The transceiver of claim 8, wherein metal-oxide semiconductor transistors of the receiving side receive a receiver adjustment signal to create a receiving apparent threshold voltage and metal-oxide semiconductor transistors of the transmitting side receive a transmitting adjustment signal to create a transmitter apparent threshold voltage.

10. The transceiver of claim 8, wherein the receiving side is comprised of low threshold voltage transistors and the transmitting side is comprised of high threshold voltage transistors.

11. The transceiver of claim 10, wherein the high threshold voltage transistors of the transmitting side are serially connected in pairs.

12. The transceiver of claim 11, wherein the low threshold voltage transistors are silicon-on-insulator dynamic threshold metal-oxide semiconductor transistors.

13. The transceiver of claim 8, wherein the transmitting side is comprised of serially connected pairs of transistors.

14. The transceiver of claim 13, wherein the receiving side is comprised of silicon-on-insulator dynamic threshold metal-oxide semiconductor transistors.

15. A method, comprising:
transmitting a reception signal from an antenna to a receiving circuit via a receiving side of a switching circuit if a receiving gate voltage of a receiving transistor circuit of the receiving side is greater than or equal to a receiving apparent threshold voltage of the receiving transistor circuit; and
transmitting a transmission signal from a transmitting circuit to the antenna via a transmitting side of the switching circuit if a transmitting gate voltage of a transmitting transistor circuit of the transmitting side is greater than or equal to a transmitting apparent threshold voltage of the transmitting transistor circuit,
wherein the receiving apparent threshold voltage is less than the transmitting apparent threshold voltage.

16. The method of claim 15, further comprising:
providing a receiver adjustment signal to the receiving transistor circuit to lower the receiving apparent threshold voltage; and
providing a transmitter adjustment signal to the transmitting transistor circuit to raise the transmitting apparent threshold voltage.

17. The method of claim 15, wherein the receiving side is comprised of low threshold voltage transistors and the transmitting side is comprised of high threshold voltage transistors.

18. The method of claim 17, wherein the high threshold voltage transistors of the transmitting side are serially connected in pairs.

19. The method of claim 15, wherein the transmitting side is comprised of serially connected pairs of transistors.

20. The method of claim 15, wherein the receiving side is comprised of silicon-on-insulator dynamic threshold metal-oxide semiconductor transistors.
